(19) United States
(12) Patent Application Publication
(10) Pub. No.: US 2021/0114241 A1
(43) Pub. Date: Apr. 22, 2021

(54) EXTERNAL CUTTING MEMBER OF A SHAVING DEVICE HAVING HAIR-GUIDING ELEMENTS WITH THICKNESS PROFILE

(71) Applicant: KONINKLIJKE PHILIPS N.V., EINDHOVEN (NL)

(72) Inventor: Sint BARON, DE KNIPE (NL)

(21) Appl. No.: 17/050,576

(22) PCT Filed: May 1, 2019
(86) PCT No.: PCT/EP2019/061158

§ 371 Date: Oct. 26, 2020

(30) Foreign Application Priority Data
May 2, 2018 (EP) 18170411.5

(51) Int. Cl. B26B 19/14; B26B 19/42

(52) U.S. Cl. CPC B26B 19/143; B26B 19/42; B26B 19/146

(57) ABSTRACT

The invention relates to an external cutting member (19) for use in a hair-cutting unit (13a, 13b, 13c) of a shaving device (1). An annular hair-cutting track (41) of the external cutting member has a central axis (43), a plurality of hair-entry openings (49), and hair-guiding elements (51) arranged between each pair of adjacent hair-entry openings. The hair-guiding elements each comprise an outer surface segment (55), an inner surface segment (57), a first side surface (59) bounding a first hair-entry opening (49a), a second side surface (61) bounding an adjacent second hair-entry opening (49b), a first cutting edge (63) at a location where the first side surface connects to the inner surface segment, and a second cutting edge (65) at a location where the second side surface connects to the inner surface segment. In a cross-section extending perpendicularly to a radial direction with respect to the central axis, each hair-guiding element has an imaginary middle axis (79) extending perpendicularly to the inner surface segment. The imaginary middle axis intersects the inner surface segment in a point of intersection (81) half-way between the first and second cutting edges, and divides a total cross-sectional area (A_{T}) of the hair-guiding element into a first cross-sectional area portion (A₁) including the first cutting edge and a second cross-sectional area portion (A₂) including the second cutting edge, the total cross-sectional area being the sum of the first and second cross-sectional area portions. According to the invention, the first cross-sectional area portion of each hair-guiding element is equal to or smaller than 48% of the total cross-sectional area of the hair-guiding element. The invention further relates to a hair-cutting unit (13a, 13b, 13c) for use in a shaving device (1), comprising an external cutting member according to the invention and an internal cutting member (21) which is rotatable relative to the external cutting member about an axis of rotation (29), wherein the internal cutting member comprises first cutting edges (69) for co-operation with the first cutting edges of the external cutting member during rotation of the internal cutting member in a first rotational direction (R1), and second cutting edges (73) for co-operation with the second cutting edges of the external cutting member during rotation of the internal cutting member in a second rotational direction (R2).

### FIELD OF THE INVENTION

The invention relates to an external cutting member for use in a hair-cutting unit of a shaving device, said external cutting member comprising an annular hair-cutting track having an outer surface for contacting a skin of a user during use, an inner surface for contacting an internal cutting member of the hair-cutting unit during use, a central axis, a plurality of hair-entry openings each extending from the outer surface to the inner surface, and a hair-guiding element arranged between a first hair-entry opening and an adjacent second hair-entry opening of the plurality of hair-entry openings, wherein said hair-guiding element comprises an outer surface segment comprised by said outer surface, an inner surface segment comprised by said inner surface, a first side surface bounding the first hair-entry opening, a second side surface bounding the second hair-entry opening, a first cutting edge at a location where the first side surface connects to the inner surface segment, and a second cutting edge at a location where the second side surface connects to the inner surface segment, wherein, in a cross-section of the hair-guiding element extending perpendicularly to a radial direction with respect to the central axis, the inner surface segment extends between the first and second cutting edges in an imaginary plane perpendicular to the central axis.

The invention further relates to a hair-cutting unit for use in a shaving device, said hair-cutting unit comprising an external cutting member as described here before and an internal cutting member which is rotatable relative to the external cutting member about an axis of rotation in a first rotational direction and in a second rotational direction opposite to the first rotational direction, wherein the internal cutting member comprises at least a first hair-cutting element comprising a first cutting edge and a second hair-cutting element comprising a second cutting edge, wherein, in a common cross-section of the first and second hair-cutting elements extending perpendicularly to a radial direction with respect to the axis of rotation, the first and second cutting edges are situated in an imaginary plane perpendicular to the axis of rotation, wherein the first cutting edge of the first hair-cutting element is arranged to co-operate with the first cutting edge of the hair-guiding element of the external cutting member during rotation of the internal cutting member in the first rotational direction, and wherein the second cutting edge of the second hair-cutting element is arranged to co-operate with the second cutting edge of the hair-guiding element of the external cutting member during rotation of the internal cutting member in the second rotational direction.

The invention further relates to a shaving head comprising a support structure including a coupling member configured to releasably couple the shaving head to a main body of a shaving device, and at least one hair-cutting unit as described here before supported by the support structure.

The invention further relates to a shaving device comprising at least one hair-cutting unit as described here before and an actuator for driving the hair-cutting unit, wherein the actuator is configured and arranged to operate in a first operational condition, wherein the actuator drives the hair-cutting unit such that the internal cutting member rotates relative to the external cutting member in the first rotational direction, and to operate in a second operational condition wherein the actuator drives the hair-cutting unit such that the internal cutting member rotates relative to the external cutting member in the second rotational direction.

The invention further relates to a shaving device comprising a main body accommodating an actuator, and a shaving head as described here before which is releasably couplable to the main body for being driven by the actuator, wherein the actuator is configured and arranged to operate in a first operational condition, wherein the actuator drives the shaving head such that the internal cutting member of the hair-cutting unit rotates relative to the external cutting member in the first rotational direction, and to operate in a second operational condition wherein the actuator drives the shaving head such that the internal cutting member of the hair-cutting unit rotates relative to the external cutting member in the second rotational direction.

### BACKGROUND OF THE INVENTION

Rotary-type electric shaving devices are well known. Such shaving devices usually have two or three hair-cutting units which each comprise an external cutting member, having an annular hair-cutting track comprising a plurality of hair-entry openings, and an internal cutting member having a plurality of hair-cutting elements arranged in an annular configuration for co-operation with the annular hair-cutting track of the external cutting member. Usually such shaving devices are configured such that the internal cutting member of each hair-cutting unit can be driven into rotation relative to the external cutting member only in a single rotational direction. In such a configuration the hair-cutting elements of the internal cutting member have cutting edges that are arranged to co-operate with counter cutting edges provided on the annular hair-cutting track of the external cutting member at their hair-entry openings during rotation of the internal cutting member relative to the external cutting in said single rotational direction.

An external cutting member, a hair-cutting unit, and a shaving device of the kinds mentioned in the section “field of the invention” are known from JP2015223315A. A user of this known shaving device can select the rotational direction of the internal cutting member of the hair-cutting units relative to the external cutting member. During rotation of the internal cutting member in a first rotational direction, first cutting edges of the internal cutting member co-operate with first cutting edges provided on the annular hair-cutting track of the external cutting member, while, during rotation of the internal cutting member in a second rotational direction opposite to the first rotational direction, second cutting edges of the internal cutting member co-operate with second cutting edges provided on the annular hair-cutting track of the external cutting member. In the known shaving device, pairs of first and second cutting edges of the internal cutting member are provided at two opposite edges of the upper surface of each of a plurality of hair-cutting elements of the internal cutting member, said upper surface being in sliding contact with an inner surface of the annular hair-cutting track of the external cutting member during use. Pairs of first and second cutting edges of the annular hair-cutting track of the external cutting member are provided on opposite edges of the inner surface segment of each of a plurality of hair-guiding elements of the annular hair-cutting track, which are each arranged between a respective one of pairs of adjacent hair-entry openings of the annular hair-cutting track, wherein said inner surface segments are comprised by the inner surface of the annular hair-cutting track. The first and second cutting edges of the internal cutting member are provided on wedge-shaped end portions of the hair-cutting elements. The wedge angle of the wedge-shaped end portions carrying the first cutting edges is smaller than the wedge angle of the wedge-shaped end portions carrying the second cutting edges, so that the first cutting edges of the internal cutting member are sharper than the second cutting edges of the internal cutting member. As a result, when selecting the first rotational direction of the internal cutting member, the known shaving device operates in a first mode providing a relatively high hair-cutting efficiency but a relatively low skin comfort and, when selecting the second rotational direction of the internal cutting member, the known shaving device operates in a second mode providing a lower hair-cutting efficiency but a higher skin comfort. Thus, a user has the option to select a preferred one of said first and second operational modes of the shaving device. However, a problem of this known shaving device is that, despite the different wedge angles of the first and second cutting edges of the internal cutting member, the difference between the shaving results provided by the first and second operational modes is relatively small.

EP 0 279 088 A1 discloses a hair-cutting unit with an external cutting member and an internal cutting member which can be driven into rotation relative to the external cutting member only in a single rotational direction. The external cutting member comprises a plurality of hair-entry openings which are separated by hair-guiding elements referred to as dams. The dams have a profile which is asymmetrical in cross-section and has a thickness which increases in the rotational direction.

EP 1 690 654 A1 discloses a hair-cutting unit with an external cutting member and an internal cutting member which can be driven into rotation relative to the external cutting member. The external cutting member comprises a plurality of hair-entry openings which are separated by hair-guiding elements referred to as ribs. The cutting edges formed at the lower ends of the side wall surfaces of the ribs have an acute angle. In a first embodiment, the two side wall surfaces of each rib are parallel and slanted, so that an acute cutting edge is formed at the lower end of only one of the two side wall surfaces facing in a direction opposite to the rotational direction of the internal cutting member. In a second embodiment, the ribs have a symmetrical cross-section, and an acute cutting edge is formed at the lower end of each of the two side wall surfaces of each rib.

### SUMMARY OF THE INVENTION

An object of the present invention is to provide an external cutting member, a hair-cutting unit, a shaving head and a shaving device of the kinds mentioned in the section “field of the invention” which provide an increased difference between the shaving results achieved during rotation of the internal cutting member in the first and second rotational directions, in particular an increased difference between closeness of the hair-cutting process and between skin comfort.

In order to achieve said object, according to the invention an external cutting member of the type mentioned in the section “field of the invention” is characterized in that, in the cross-section of the hair-guiding element extending perpendicularly to the radial direction with respect to the central axis, the hair-guiding element has an imaginary middle axis extending perpendicularly to the inner surface segment, intersecting the inner surface segment in a point of intersection half-way between the first and second cutting edges, and dividing a total cross-sectional area of the hair-guiding element into a first cross-sectional area portion including the first cutting edge and a second cross-sectional area portion including the second cutting edge, wherein the total cross-sectional area is the sum of the first and second cross-sectional area portions, and wherein the first cross-sectional area portion of the hair-guiding element is equal to or smaller than 48% of the total cross-sectional area of the hair-guiding element.

In the light of the present invention, the term “cutting edge” is to be interpreted as an edge having a radius of curvature enabling hair cutting in co-operation with a counter cutting edge. In particular the radius of curvature of the cutting edge is equal to or smaller than 30 micrometers, more preferably equal to or smaller than 20 micrometers, and most preferably equal to or smaller than 15 micrometers. The external cutting member according to the invention is intended for use in a hair-cutting unit further comprising an internal cutting member which is rotatable relative to the external cutting member in mutually opposite first and second rotational directions about an axis of rotation substantially coinciding with the central axis of the annular hair-cutting track of the external cutting member. In particular the internal cutting member has a plurality of hair-cutting elements which are in sliding contact with the inner surface of the annular hair-cutting track during rotation of the internal cutting member about the central axis of the external cutting member. In particular the hair-cutting elements of the internal cutting member have first cutting edges for co-operation with the first cutting edge of the hair-guiding element of the external cutting member during rotation of the internal cutting member in the first rotational direction, and second cutting edges for co-operation with the second cutting edge of the hair-guiding element during rotation of the internal cutting member in the second rotational direction. To enable proper contact, during rotation of the internal cutting member, between the hair-cutting elements and the inner surface segment of the hair-guiding element comprising the first and second cutting edges of the external cutting member, the inner surface segment extends in an imaginary plane perpendicular to the central axis, seen in said cross-section of the hair-guiding element.

Because, according to the invention, said first cross-sectional area portion of the hair-guiding element is equal to or smaller than 48% of said total cross-sectional area of the hair-guiding element, the first cross-sectional area portion including the first cutting edge has an average thickness, measured in a direction perpendicular to the inner surface segment, smaller than an average thickness of the second cross-sectional area portion of the hair-guiding element including the second cutting edge. In particular the average thickness of the first cross-sectional area portion is equal to or smaller than 92.3% (48/52) of the average thickness of the second cross-sectional area portion. As a result, under the influence of a local pressure exerted during use on the user's skin by the hair-guiding element, the skin will penetrate into the hair-entry opening bounded by the first side surface of the hair-guiding element to a larger extent as compared to the hair-entry opening bounded by the second side surface of the hair-guiding element. As a result, the skin will be closer to the first cutting edge of the hair-guiding element than to the second cutting edge of the hair-guiding element. As a result, when the internal cutting member is rotated in the first rotational direction and hair cutting takes place at the first cutting edge of the hair-guiding element, the hairs will be cut in positions relatively close to the skin, so that a relatively smooth and long-lasting shaving result will be achieved. In this first mode of operation, however, the risk of skin irritation is increased as a result of the relatively close position of the skin to the first cutting edge. On the other hand, when the internal cutting member is rotated in the second rotational direction and hair cutting takes place at the second cutting edge of the hair-guiding element, the hairs will be cut in positions less close to the skin, so that a less smooth shaving result will be achieved. In this second mode of operation, the risk of skin irritation is relatively small and the level of skin comfort is considerably increased as compared to the first mode of operation. Thus, said difference between the average thicknesses of the first and second cross-sectional area portions of the hair-guiding element provides considerable differences in the balance between closeness of the shaving process and skin comfort in the first and second modes of operation of the shaving device, thus providing the user with the option to select between two very distinct modes of operation.

In a preferred embodiment of an external cutting member according to the invention, the first cross-sectional area portion is between 30% and 45% of the total cross-sectional area. In this preferred embodiment the average thickness of the first cross-sectional area portion is between 42.9% (30/70) and 81.8% (45/55) of the average thickness of the second cross-sectional area portion. These ratios provide optimum differences in the balance between closeness of the shaving process and skin comfort resulting from the use of the hair-cutting unit, comprising the external cutting member according to the invention, with the internal cutting member rotating in either the first or the second rotational direction.

In a further embodiment of an external cutting member according to the invention, a hair-guiding element is arranged between each pair of adjacent hair-entry openings of the plurality of hair-entry openings. In this embodiment, a hair-guiding element comprising the first and second cutting edges and comprising the first and second cross-sectional area portions in accordance with the present invention is arranged between each pair of adjacent hair-entry openings of the plurality of hair-entry openings of the external cutting member. In this way, the differences between the hair-cutting results achieved at the first and second cutting edges of the hair-guiding elements are turned to account to the maximum extent possible.

In a further embodiment of an external cutting member according to the invention, in said cross-section of the hair-guiding element a thickness of the hair-guiding element measured in a direction perpendicular to the inner surface segment has a maximum value at a maximum-thickness position between the imaginary middle axis and the second cutting edge, wherein said thickness increases from the first cutting edge to the maximum-thickness position and decreases from the maximum-thickness position to the second cutting edge. In this way, a ratio between the first cross-sectional area portion and the total cross-sectional area of the hair-guiding element in accordance with the invention is achieved by means of a simple geometry of the cross-section of the hair-guiding element. Furthermore a considerable difference is achieved between the degree of skin penetration into the hair-entry openings at the first and second cutting edges of the hair-guiding element. The thickness of the hair-guiding element may increase continuously or gradually from the first cutting edge to the maximum-thickness position and may decrease continuously or gradually from the maximum-thickness position to the second cutting edge. Alternatively the thickness of the hair-guiding element may be constant over a portion of the first or second cross-sectional area portions.

In a further preferred embodiment of an external cutting member according to the invention, the hair-guiding element has the first cross-sectional area portion and the second cross-sectional area portion in a cross-section perpendicular to the radial direction in any position from a first distance from the central axis to a second distance from the central axis different from the first distance. In this embodiment the hair-guiding element may have an elongate shape with a main extension in the radial direction relative to the central axis. Alternatively the hair-guiding element may be partially elongate in said radial direction. In this embodiment, any cross-section of the hair-guiding element, perpendicular to the radial direction, within a range of distances from the central axis between said first and second distances has a ratio between the first cross-sectional area portion and the total cross-sectional area in accordance with the invention. This enables the differences between the hair-cutting results achieved at the first and second cutting edges of the hair-guiding element to be turned to account over said full range of distances from the central axis. In particular, said range of distances may correspond to a radial extension of the co-operating cutting edges of the internal cutting member.

In a yet further preferred embodiment of an external cutting member according to the invention, in positions at said first and second distances from the central axis the total cross-sectional area of the hair-guiding element is larger than the total cross-sectional area of the hair-guiding element in a position at a third distance from the central axis between said first and second distances. This embodiment is of particular advantage when the cutting edges of the internal cutting member co-operating with the external cutting member extend in the radial direction relative to the central axis from said first distance to said second distance from the central axis. The risk of skin damage by the end portions of the cutting edges of the internal cutting member, which are present at said first and second distances from the central axis, is relatively high during rotation of the internal cutting member. The larger cross-sectional area of the hair-guiding element at said first and second distances from the central axis results in a larger average thickness of the hair-guiding element at said first and second distances as compared to a central portion of the hair-guiding element between said first and second distances. Said larger average thickness reduces the degree of penetration of the skin into the hair-entry openings at said first and second distances from the central axis, thereby protecting the skin against any potential increased damage caused by the end portions of the cutting edges of the rotating internal cutting member. In addition, said larger average thickness of the hair-guiding element at said first and second distances increases the stiffness of the hair-guiding element. In this embodiment, the total cross-sectional area of the hair-guiding element may continuously or gradually vary from said first distance to said second distances from the central axis. In particular, the total cross-sectional area of the hair-guiding element may continuously or gradually decrease from a maximum value present at said first distance to a minimum value present at said third distance from the central axis, and my continuously or gradually increase from said minimum value present at said third distance to said maximum value present at said second distance from the central axis.

According to the invention, a hair-cutting unit of the type mentioned in the section “field of the invention” is characterized in that the external cutting member used therein is an external cutting member according to the invention as described here before. The first hair-cutting element, comprising the first cutting edge of the internal cutting member arranged to co-operate with the first cutting edge of the hair-guiding element of the external cutting member during rotation of the internal cutting member in the first rotational direction, and the second hair-cutting element, comprising the second cutting edge of the internal cutting member arranged to co-operate with the second cutting edge of the hair-guiding element of the external cutting member during rotation of the internal cutting member in the second rotational direction, may be embodied by two spatially separated carrying elements each carrying a respective one of the first and second cutting edges of the internal cutting member on an end portion, in particular on an upper surface of said end portion. Said two spatially separated carrying elements may be mounted to or integrally formed on a base portion of the internal cutting member. Alternatively, the first and second hair-cutting elements may be supported by a common carrying element mounted to or integrally formed on a base portion of the internal cutting member. To enable proper contact, during rotation of the internal cutting member, between the first and second hair-cutting elements of the internal cutting member and the inner surface segment of the hair-guiding element comprising the first and second cutting edges of the external cutting member, the first and second cutting edges of the first and second hair-cutting elements are situated in an imaginary plane perpendicular to the axis of rotation, seen in a common cross-section of the first and second hair-cutting elements extending perpendicularly to a radial direction with respect to the axis of rotation.

In a preferred embodiment of a hair-cutting unit according to the invention, the first and second hair-cutting elements are integrally formed on a carrying element which comprises an upper surface for contacting the inner surface of the external cutting member during use, a first side surface connected to the upper surface via the first cutting edge of the first hair-cutting element, and a second side surface connected to the upper surface via the second cutting edge of the second hair-cutting element, wherein, in said common cross-section of the first and second hair-cutting elements, the upper surface extends in said imaginary plane perpendicular to the axis of rotation. In this embodiment, the first and second cutting edges of the internal cutting member are integrally formed on opposite edges of said upper surface of said carrying element. In this embodiment, the first hair-cutting element may constitute a first upper portion of said carrying element comprising the first cutting edge, and the second hair-cutting element may constitute a second upper portion of said carrying element comprising the second cutting edge. Said carrying element may be mounted to or integrally formed on a base portion of the internal cutting member. The internal cutting member may comprise a plurality of such carrying elements each provided with a first and a second cutting edge on its upper surface.

In a further embodiment of a hair-cutting unit according to the invention, in said common cross-section of the first and second hair-cutting elements, the first side surface and the upper surface of the carrying element enclose a first cutting-edge angle at the location of the first cutting edge of the first hair-cutting element, and the second side surface and the upper surface of the carrying element enclose a second cutting-edge angle at the location of the second cutting edge of the second hair-cutting element, wherein the first cutting-edge angle is smaller than the second cutting-edge angle. Because the first cutting-edge angle of the first cutting edge is smaller than the second cutting-edge angle of the second cutting edge, the difference between the hair-cutting efficiencies and the difference between the degrees of skin comfort of the hair-cutting unit with the internal cutting member rotating, respectively, in the first rotational direction and in the second rotational direction are further increased, because generally, with a decrease of the cutting-edge angle of a cutting edge, the hair-cutting efficiency at said cutting edge increases but the level of skin comfort at said cutting edge decreases.

In a further embodiment of a hair-cutting unit according to the invention, the internal cutting member further comprises a hair-retraction element arranged in front of the carrying element seen in the first rotational direction for co-operation with the first cutting edge of the first hair-cutting element, said hair-retraction element comprising an end surface having a cutting edge at a side of the end surface remote from the carrying element, said hair-retraction element being moveably guided relative to the carrying element along the first side surface of the carrying element, and said hair-retraction element being urged by spring force towards the inner surface of the external cutting member. Such a hair-retraction element is known as such and further increases the closeness of the hair-cutting process at the first cutting edge of the internal cutting member. During operation, a hair to be cut by the first cutting edge will first be gripped by the cutting edge of the hair-retraction element and will be partially extracted from the skin by retraction of the hair-retraction element relative to the first cutting edge. As a result, the partially extracted hair will subsequently be cut by the first cutting edge in a position closer to the skin as compared to a hair-cutting process not using a hair-retraction element. As a result, the hair-retraction element further increases the difference between the closeness of the hair-cutting process of the hair-cutting unit with the internal cutting member rotating, respectively, in the first rotational direction and in the second rotational direction.

According to the invention, a shaving head of the type mentioned in the section “field of the invention” is characterized in that the hair-cutting unit used therein is a hair-cutting unit according to the invention as described here before. The coupling member may be centrally arranged on a bottom wall of the support structure and may accommodate a single centrally arranged drive shaft configured to drive a plurality of hair-cutting units via a transmission unit arranged in the support structure. By coupling the shaving head to the main body of the shaving device, the single drive shaft of the shaving head may be coupled to a single drive shaft of the main body driven by a motor arranged in the main body.

According to the invention, a shaving device of the type mentioned in the section “field of the invention” and comprising at least one hair-cutting unit is characterized in that the hair-cutting unit used therein is a hair-cutting unit according to the invention. The actuator for driving the hair-cutting unit may be an electric rotary motor which can selectively operate in two opposite rotational directions.

According to the invention, a shaving device of the type mentioned in the section “field of the invention” and comprising a shaving head is characterized in that the shaving head used therein is a shaving head according to the invention. The actuator for driving the shaving head is accommodated in the main body of the shaving device and may be an electric rotary motor which can selectively operate in two opposite rotational directions. When the shaving head is coupled to the main body, the electric motor may selectively drive the internal cutting member of the hair-cutting unit of the shaving head in the first rotational direction or in the second rotational direction.

A preferred embodiment of a shaving device according to the invention further comprises a control unit configured and arranged to selectively control the actuator to operate in the first or the second operational condition. The control unit may control the operational condition of the actuator based on user input. In such an embodiment, the shaving device may further comprise a user input member enabling the user to select the first and second operational conditions. Alternatively the control unit may automatically control the operational condition of the actuator, for example based on sensor input or software.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows an embodiment of a shaving device according to the invention;

FIG. 2 shows an embodiment of a shaving head according to the invention used in the shaving device of FIG. 1;

FIG. 3 shows a first embodiment of a hair-cutting unit according to the invention used in the shaving head of FIG. 2;

FIG. 4 is a schematic perspective view of a single hair-guiding element of an external cutting member according to the invention used in the hair-cutting unit of FIG. 3 and a single hair-cutting body of an internal cutting member used in the hair-cutting unit of FIG. 3;

FIG. 5 schematically shows a cross-section of the hair-guiding element of FIG. 4 extending perpendicularly to a radial direction with respect to a central axis of the external cutting member;

FIG. 6A schematically shows a cross-section of the hair-cutting body of FIG. 4 extending perpendicularly to a radial direction with respect to an axis of rotation of the internal cutting member, with the internal cutting member rotating in a first rotational direction;

FIG. 6B schematically shows the cross-section of FIG. 6A, with the internal cutting member rotating in a second rotational direction;

FIG. 7 schematically shows a cross-section of a hair-cutting body and hair-guiding elements in a second embodiment of a hair-cutting unit according to the invention; and

FIG. 8 schematically shows a cross-section of a hair-cutting body and hair-guiding elements in a third embodiment of a hair-cutting unit according to the invention

### DETAILED DESCRIPTION OF THE EMBODIMENTS

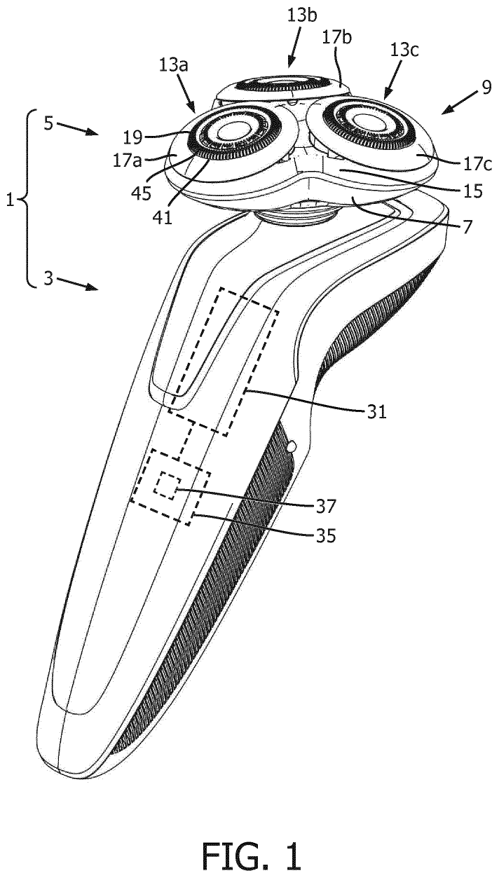

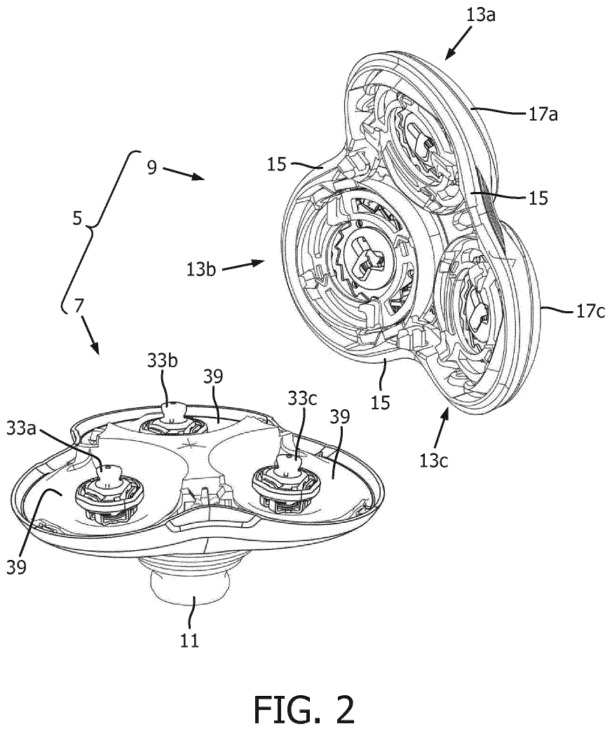

FIG. 1 shows an embodiment of a shaving device 1 according to the invention. The shaving device 1 comprises a main body 3 designed to be held by a user's hand during operation. The shaving device 1 further comprises a shaving head 5 according to the invention. The shaving head 5 is shown in detail in FIG. 2 and comprises a support structure 7 and a shaving unit 9 that is releasably couplable to the support structure 7. The support structure 7 comprises a centrally arranged coupling member 11 by means of which the shaving head 5 is releasably couplable to the main body 3. FIG. 1 shows the shaving head 5 in an operational condition wherein the shaving unit 9 is coupled to the support structure 7 and wherein the shaving head 5 is coupled to the main body 3. FIG. 2 shows the shaving head 5 in a condition wherein the shaving head 5 is released from the main body 3 and wherein the shaving unit 9 is released from the support structure 7.

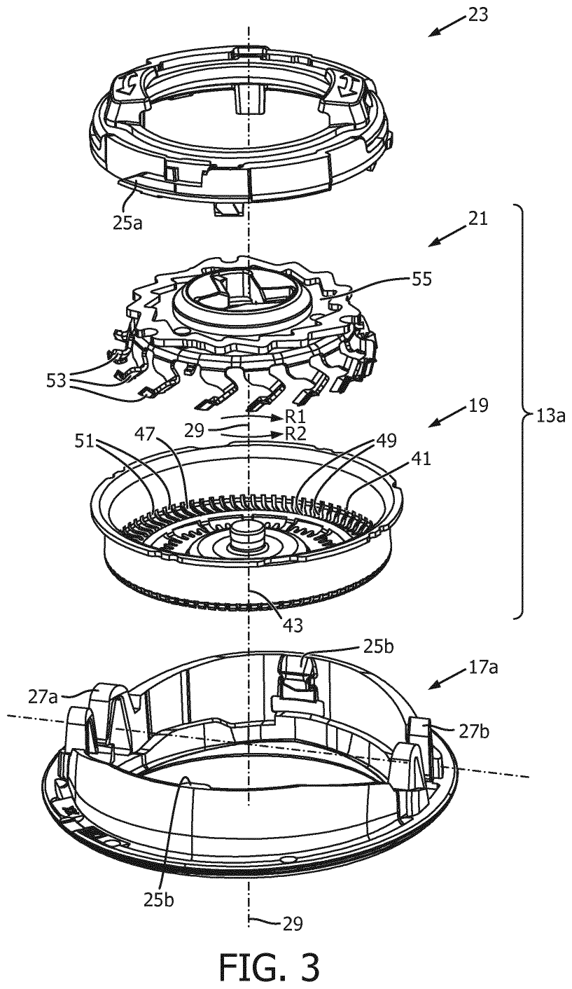

The shaving head 5 comprises three hair-cutting units 13a, 13b, 13c according to the invention. In the operational condition of the shaving head 5, the hair-cutting units 13a, 13b, 13c are supported by a supporting member 15 of the shaving unit 9. In particular the hair-cutting units 13a, 13b, 13c are each supported by a respective one of three skin-supporting members 17a, 17b, 17c that are pivotally mounted to the supporting member 15 of the shaving unit 9 and each surround a respective one of the hair-cutting units 13a, 13b, 13c. FIG. 3 shows the hair-cutting unit 13a in detail, including the associated skin-supporting member 17a. The hair-cutting units 13b, 13c are identical to the hair-cutting unit 13a. In particular, FIG. 3 shows the hair-cutting unit 13a in a disassembled condition. The hair-cutting unit 13a comprises an external cutting member 19 according to the invention, an internal cutting member 21, and a retaining member 23. In an assembled condition of the hair-cutting unit 13a as shown in FIG. 2, the external cutting member 19 is arranged in the skin-supporting member 17a, the internal cutting member 21 is arranged in the external cutting member 19, and the external and internal cutting members 19, 21 are held in position in the skin-supporting member 17a by means of the retaining member 23 which is releasably couplable to the skin-supporting member 17a by means of a snap connection 25a, 25b. The skin-supporting member 17a is pivotally mounted to the supporting member 15 of the shaving unit 9 by means of a hinge structure 27a, 27b.

In the operational condition of the shaving head 5 with the hair-cutting units 13a, 13b, 13c in their assembled condition, each internal cutting member 21 is rotatable relative to the associated external cutting member 19 about an axis of rotation 29 shown in FIG. 3. The shaving device 1 comprises an actuator 31 accommodated in the main body 3. In the embodiment shown in FIG. 1 the actuator 31 comprises an electric rotary motor that is shown only schematically. In the operational condition of the shaving head 5, the actuator 31 can drive the internal cutting members 21 of the hair-cutting units 13a, 13b, 13c into rotation relative to the external cutting members 19 via a transmission unit, that includes transmission elements accommodated in the main body 3 and in the support structure 7 of the shaving head 5 (not shown) and further includes three drive spindles 33a, 33b, 33c (shown in FIG. 2) that are each arranged in the support structure 7 for being releasably coupled to a respective one of the three internal cutting members 19. The actuator 31 is configured and arranged to operate in a first operational condition, wherein the actuator 31 drives the hair-cutting units 13a, 13b, 13c such that the internal cutting members 21 rotate relative to the external cutting members 19 in a first rotational direction R1 about the axes of rotation 29, and to operate in a second operational condition, wherein the actuator 31 drives the hair-cutting units 13a, 13b, 13c such that the internal cutting members 21 rotate relative to the external cutting members 19 is a second rotational direction R2 about the axes of rotation 29 opposite to the first rotational direction R1. The shaving device 1 comprises a control unit 35 that is shown schematically in FIG. 1 and is configured and arranged to selectively control the actuator 31 to operate in the first operational condition or in the second operational condition. The shaving device 1 further comprises a user input member 37 that is shown schematically in FIG. 1 and enables the user to select the first and second operational conditions. The user input member 37 may be a simple control knob or a touch panel. When the actuator 31 comprises an electric rotary motor, the control unit 35 may control a power supply unit of the rotary motor such as to selectively drive the motor in one of two rotational directions depending on the selected operational condition.

It is noted that a shaving device according to the invention may alternatively have a support structure supporting at least one hair-cutting unit according to the invention, wherein the support structure is mounted in a fixed position relative to the main body of the shaving device. Furthermore, in a shaving device according to the invention having a shaving head according to the invention that is releasably coupled to the main body, the support structure of the shaving head may have a different coupling member than the centrally arranged coupling member 11 as described here before. For example, the support structure may have a shape similar to the supporting member 15 as described here before, wherein the support structure is releasably coupled to the main body by means of a hinge structure. In such an embodiment, in the operational condition a hair collecting chamber of the shaving device is enclosed by the support structure and an upper wall of the main body, whereas in the embodiment shown in FIG. 2 a hair collecting chamber 39 is enclosed by the support structure 7 and the shaving unit 9 in the operational condition of the shaving head 5.

As shown in FIG. 1 and FIG. 3, the external cutting member 19 according to the invention comprises an annular hair-cutting track 41 that is arranged concentrically around a central axis 43 of the annular hair-cutting track 41 and the external cutting member 19. In the assembled condition of the hair-cutting unit 13a, the central axis 43 substantially coincides with the axis of rotation 29. The annular hair-cutting track 41 has an annular outer surface 45 (visible in FIG. 1) that is in contact with the skin of the user during use. The annular hair-cutting track 41 has an annular inner surface 47 (visible in FIG. 3) that is in contact with the internal cutting member 21 of the hair-cutting unit 13a during use. The annular hair-cutting track 41 further comprises a plurality of hair-entry openings 49 each extending from the annular outer surface 45 to the annular inner surface 47. In the embodiment of the external cutting member 19 shown in FIG. 3, the hair-entry openings 49 are slot-shaped and each have a main direction of extension in a radial direction relative to the central axis 43. Between each pair of adjacent hair-entry openings 49 of the plurality of hair-entry openings 49 of the annular hair-cutting track 41, a hair-guiding element 51 is arranged. In the embodiment of the external cutting member 19 shown in FIG. 3, the hair-guiding elements 51 are lamella-shaped and each have a main direction of extension in a radial direction relative to the central axis 43.

As shown in FIG. 3, the internal cutting member 21 comprises a plurality of hair-cutting bodies 53. The hair-cutting bodies 53 are annularly arranged and integrally formed on a base portion 55 of the internal cutting member 21. In the assembled condition of the hair-cutting unit 13a, the hair-cutting bodies 53 are arranged along the annular inner surface 47 of the annular hair-cutting track 41 of the external cutting member 19 so that, during rotation of the internal cutting member 21 relative to the external cutting member 19, the hair-cutting bodies 53 are in sliding contact with the annular inner surface 47 of the annular hair-cutting track 41.

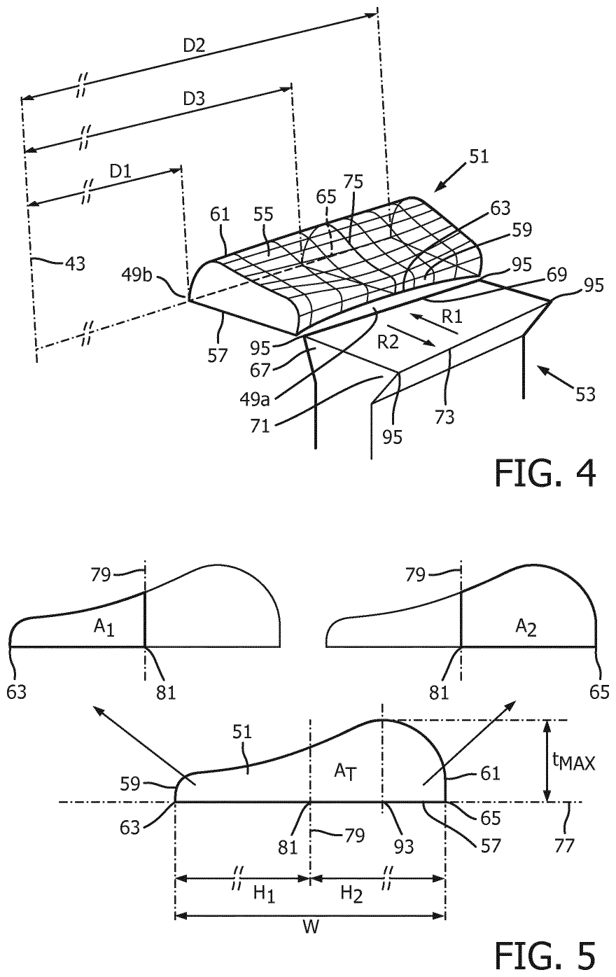

FIG. 4 shows a single hair-guiding element 51 of the external cutting member 19 of the hair-cutting unit 13a together with a single hair-cutting body 53 of the internal cutting member 21 of the hair-cutting unit 13a in a schematic perspective view. The remaining hair-guiding elements 51 of the external cutting member 19 and the remaining hair-cutting bodies 53 of the internal cutting member 21 have similar characteristics as described hereafter with respect to the single hair-guiding element 51 and the single hair-cutting body 53 shown in FIG. 4.

In FIG. 4 the reference numbers 49a and 49b respectively indicate a first hair-entry opening and an adjacent second hair-entry opening of the annular hair-cutting track 41 between which the hair-guiding element 51 is arranged. As shown in FIG. 4, the hair-guiding element 51 of the external cutting member 19 comprises an outer surface segment 55, comprised by the annular outer surface 45 of the annular hair-cutting track 41, and an inner surface segment 57 comprised by the annular inner surface 47 of the annular hair-cutting track 41. The hair-guiding element 51 further comprises a first side surface 59, bounding the first hair-entry opening 49a, and a second side surface 61 bounding the second hair-entry opening 49b. At the location where the first side surface 59 connects to the inner surface segment 57, the hair-guiding element 51 comprises a first cutting edge 63. At the location where the second side surface 61 connects to the inner surface segment 57, the hair-guiding element 51 comprises a second cutting edge 65. The first and second cutting edges 63, 65 of the hair-guiding element 51 are sufficiently sharp to enable cutting through of hairs in co-operation with counter cutting edges provided on the hair-cutting bodies 53 to be described hereafter. Preferably the first and second cutting edges 63, 65 of the hair-guiding element 51 have a radius of curvature equal to or smaller than 30 micrometers, more preferably equal to or smaller than 20 micrometers, and most preferably equal to or smaller than 15 micrometers.

As further shown in FIG. 4, the hair-cutting body 53 of the internal cutting member 21 comprises a first hair-cutting element 67, comprising a first cutting edge 69, and a second hair-cutting element 71 comprising a second cutting edge 73. The first cutting edge 69 of the hair-cutting body 53 is arranged to co-operate with the first cutting edges 63 of the hair-guiding elements 51 of the external cutting member 19 when the internal cutting member 21 rotates in the first rotational direction R1 relative to the external cutting member 19. The second cutting edge 73 of the hair-cutting body 53 is arranged to co-operate with the second cutting edges 65 of the hair-guiding elements 51 of the external cutting member 19 when the internal cutting member 21 rotates in the second rotational direction R2 relative to the external cutting member 19. The first and second cutting edges 69, 73 of the hair-cutting body 53 are sufficiently sharp to enable cutting through of hairs in co-operation with, respectively, the first and second cutting edges 63, 65 provided on the hair-guiding elements 51 of the external cutting member 19. Preferably the first and second cutting edges 69, 73 of the hair-cutting body 53 have a radius of curvature equal to or smaller than 30 micrometers, more preferably equal to or smaller than 20 micrometers, and most preferably equal to or smaller than 15 micrometers.

FIG. 5 schematically shows a cross-section of the hair-guiding element 51 shown in FIG. 4. Said cross-section is indicated by reference number 75 in FIG. 4 and extends perpendicularly to a radial direction with respect to the central axis 43 of the external cutting member 19. In said cross-section, the inner surface segment 57 of the hair-guiding element 51 extends between the first and second cutting edges 63, 65 of the hair-guiding element 51 in an imaginary plane 77 extending perpendicularly to the central axis 43. In said cross-section, the first and second cutting edges 69, 73 of the first and second hair-cutting elements 67, 71 of the hair-cutting bodies 53 of the internal cutting member 21 move parallel to said imaginary plane 77 and in sliding contact with the inner surface segment 57 during rotation of the internal cutting member 21 about the axis of rotation 29. In said cross-section, furthermore the hair-guiding element 51 has an imaginary middle axis 79 extending perpendicularly to the inner surface segment 57. The imaginary middle axis 79 intersects the inner surface segment 57 in a point of intersection 81 half-way between the first and second cutting edges 63, 65 of the hair-guiding element 51. In other words, the width W of the hair-guiding element 51 is divided into two equal halves H₁ and H₂ by the imaginary middle axis 79 as shown in FIG. 5. Thus, the imaginary middle axis 79 divides a total cross-sectional area A_{T} of the hair-guiding element 51 into a first cross-sectional area portion A₁, including the first cutting edge 63 and extending from the first cutting edge 63 until the imaginary middle axis 79, and a second cross-sectional area portion A₂, including the second cutting edge 65 and extending from the second cutting edge 65 until the imaginary middle axis 79. Thus, the total cross-sectional area A_{T} is the sum of the first cross-sectional area portion A₁ and the second cross-sectional area portion A₂.

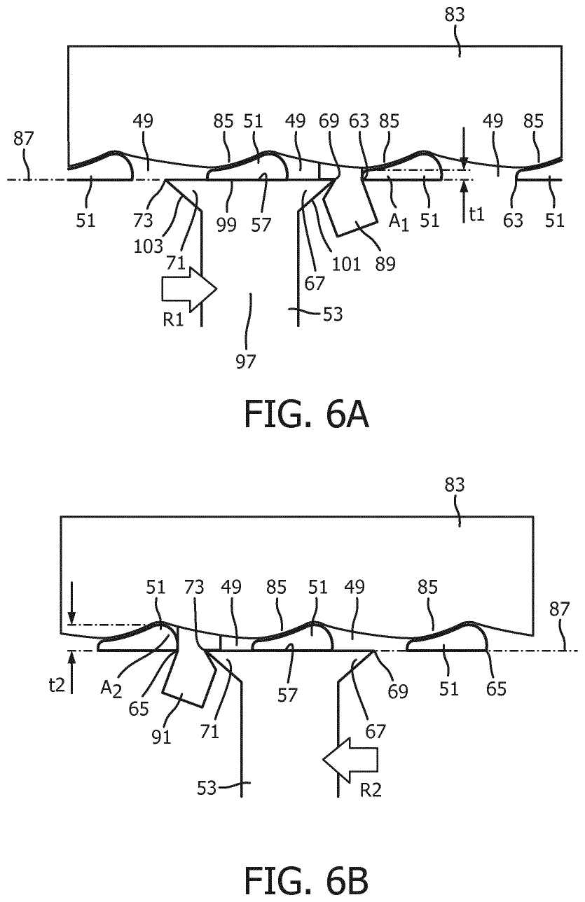

According to the invention, the first cross-sectional area portion A₁ of the hair-guiding element 51 is smaller than the second cross-sectional area portion A₂. In particular, the first cross-sectional area portion A₁ is equal to or smaller than 48% of the total cross-sectional area A_{T} of the hair-guiding element 51. As a result, an average thickness of the first cross-sectional area portion A₁, measured in a direction perpendicular to the inner surface segment 57, is smaller than an average thickness of the second cross-sectional area portion A₂ as is readily visible in FIG. 5. In particular, the average thickness of the first cross-sectional area portion A₁ is equal to or smaller than 92.3% (48/52) of the average thickness of the second cross-sectional area portion A₂. The technical effect of this average thickness ratio between the first and second cross-sectional area portions A₁ and A₂ of the hair-guiding element 51 will be discussed hereafter with reference to FIG. 6A and FIG. 6B.

FIG. 6A and FIG. 6B schematically show a cross-section of the hair-cutting body 53 extending perpendicularly to a radial direction with respect to the axis of rotation 29 of the internal cutting member 21. FIGS. 6A and 6B also show a number of adjacent hair-guiding elements 51 of the external cutting member 19 in said cross-section, which substantially coincides with the cross-section of the hair-guiding element 51 shown in FIG. 5. In the cross-section of FIGS. 6A and 6B, constituting a common cross-section of the first and second hair-cutting elements 67, 71 of the hair-cutting body 53, the first and second cutting edges 69, 73 of the first and second hair-cutting elements 67, 71 are situated in an imaginary plane 87 extending perpendicular to the axis of rotation 29. The imaginary plane 87 substantially coincides with the imaginary plane 77 shown in FIG. 5. As a result the first and second hair-cutting elements 67, 71 of the hair-cutting body are in sliding contact with the inner surface segments 57 of the hair-guiding elements 51 during rotation of the internal cutting member 21 about the axis of rotation 29.

In FIGS. 6A and 6B, the hair-guiding elements 51 are in pressure contact with the skin 83 of the user during use of the shaving device 1. As a result of said pressure contact, the skin 83 partially penetrates into the hair-entry openings 49 between the hair-guiding elements 51, thereby forming skin bulges 85 in the hair-entry openings 49. FIG. 6A shows the first operational condition of the actuator 31, wherein the internal cutting member 21 is driven to rotate relative to the external cutting member 19 in the first rotational direction R1 about the axis of rotation 29. FIG. 6B shows the second operational condition of the actuator 31, wherein the internal cutting member 21 is driven to rotate in the second rotational direction R2 opposite to the first rotational direction R1.

During rotation of the internal cutting member 21 in the first rotational direction R1 as shown in FIG. 6A, the first cutting edge 69 of the hair-cutting body 53 co-operates with the first cutting edges 63 of the hair-guiding elements 51. Because, as described here before, the first cross-sectional area portions A₁ of the hair-guiding elements 51 have a relatively small average thickness (schematically indicated by t1 in FIG. 6A), the skin 83 bulges over a relatively large distance into the hair-entry openings 49 at the location of the first cutting edges 63 of the hair-guiding elements 51. As a result, hairs 89 penetrating into the hair-entry openings 49 will be cut in a position relatively close to the surface of the skin 83 by the first cutting edge 69 of the hair-cutting body 53 and the first cutting edge 63 of the co-operating hair-guiding element 51. During rotation of the internal cutting member 21 in the second rotational direction R2 as shown in FIG. 6B, the second cutting edge 73 of the hair-cutting body 53 co-operates with the second cutting edges 65 of the hair-guiding elements 51. Because, as described here before, the second cross-sectional area portions A₂ of the hair-guiding elements 51 have a relatively large average thickness (schematically indicated by t2 in FIG. 6B), the skin 83 bulges over a relatively small distance into the hair-entry openings 49 at the location of the second cutting edges 65 of the hair-guiding elements 51. As a result, hairs 91 penetrating into the hair-entry openings 49 will be cut in a position less close to the surface of the skin 83 (as compared to FIG. 6A) by the second cutting edge 73 of the hair-cutting body 53 and the second cutting edge 65 of the co-operating hair-guiding element 51. As a result, in the first operational condition of the actuator 31 with the internal cutting member 21 rotating in the first rotational direction R1, a relatively smooth and long-lasting shaving result will be achieved, but the risk of skin irritation is increased as a result of the relatively close position of the skin to the first cutting edges 69 of the rotating internal cutting member 21. To the contrary, in the second operational condition of the actuator 31 with the internal cutting member 21 rotating in the second rotational direction R2, a less smooth shaving result will be achieved, but the risk of skin irritation is relatively low and the level of skin comfort is relatively high as compared to the first operational condition. Thus, by selecting between the first and second operational conditions, i.e. by selecting between the two opposite rotational directions R1 and R2 of the internal cutting member 21, the user can select between a relatively smooth and long-lasting shaving result with a relatively low degree of skin comfort and a less smooth shaving result with a relatively high degree of skin comfort.

Preferably the first cross-sectional area portion A₁ of each hair-guiding element 51 is between 30% and 45% of the total cross-sectional area A_{T}. In such preferred embodiments, the ratio t1/t2 between the average thicknesses of the first and second cross-sectional area portions A₁ and A₂ is between 42.9% (30/70) and 81.8% (45/55). A ratio t1/t2 in this range provides an optimum difference between the first and second rotational directions R1, R2 as regards the balance between closeness of the shaving result and skin comfort.

As shown in the cross-section of the hair-guiding element 51 in FIG. 5, the hair-guiding element 51 has a maximum thickness t_{MAX}, measured in a direction perpendicular to the inner surface segment 57, at a maximum-thickness position 93 on the inner surface segment 57 that is between the imaginary middle axis 79 and the second cutting edge 65 of the hair-guiding element 51. In this cross-section, the thickness of the hair-guiding element 51 steadily increases from the first cutting edge 63 to the maximum-thickness position 93 and steadily decreases from the maximum-thickness position 93 to the second cutting edge 65. In this manner a ratio between the first cross-sectional area portion A₁ and the total cross-sectional area A_{T} of the hair-guiding element 51 in accordance with the invention is achieved by means of a simple cross-sectional geometry of the hair-guiding element 51. Whereas the embodiment of FIG. 5 shows a more or less continuous or gradual increase and decrease of the thickness of the hair-guiding element 51 from, respectively, the first cutting edge 63 to the maximum-thickness position 93 and the maximum-thickness position 93 to the second cutting edge 65, the hair-guiding element 51 may have an alternative thickness profile resulting in a ratio A₁/A_{T} in accordance with the invention. The thickness may for example be constant over parts of the first and second cross-sectional area portions. The thickness may for example increase or decrease stepwise instead of gradually.

As further shown in FIG. 4, the hair-guiding element 51 has a cross-section, wherein A₁/A_{T} is equal to or smaller than 48% in accordance with the invention, in any radial position relative to the central axis 43 of the external cutting member 19 from a first distance D1 from the central axis 43 until a second distance D2 from the central axis 43 greater than the first distance D1. In this way, the different hair-cutting results for the first and second rotational directions R1 and R2 of the internal cutting member 21 as described with reference to FIGS. 6A and 6B are achieved in any radial position on the hair-guiding element 51 from the first distance D1 until the second distance D2 from the central axis 43. In the embodiment of FIG. 4, the range of distances between the first distance D1 and the second distance D2 corresponds to a radial extension of the first and second cutting edges 69 and 73 of the internal cutting member 21. In alternative embodiments, however, the hair-guiding element 51 may have a cross-section, wherein A₁/A_{T} is equal to or smaller than 48% in accordance with the invention, only in a limited range of radial positions relative to the central axis 43. In such alternative embodiments the hair-guiding element may have a cross-section, wherein A1=A2=0.5*A_{T}, in other radial positions.

In FIG. 4 the hair-guiding element 51 has an elongate shape with a main extension in a radial direction relative to the central axis 43, while the inner surface segment 57 extends in an imaginary plane perpendicular to the central axis 43. In alternative embodiments the hair-guiding elements 51 may extend obliquely relative to the radial direction or may for example have a V-shape. In still alternative embodiments the inner surface segments 57 of the hair-guiding elements 51 may be curved seen in a radial cross-section extending through the central axis 43. In such embodiments the first and second cutting edges 69, 73 of the internal cutting member 21 have a corresponding curved shape.

As readily visible in FIG. 4, the total cross-sectional area A_{T} of the hair-guiding element 51 in the radial positions at the first and second distances D1 and D2 from the central axis 43 is larger than the total cross-sectional area A_{T} of the hair-guiding element 51 in a radial position at a third distance D3 from the central axis 43 between the first and second distances D1 and D2. As a result, the cross-section of the hair-guiding element 51 has an increased average thickness in its radial end portions as compared to the average thickness of the cross-section of the hair-guiding element 51 in a central portion between the two radial end portions. Said increased average thickness of the radial end portions of the hair-guiding element 51 protects the skin against irritation and damage that may be caused by contact with the sharp radial end portions 95 of the first and second cutting edges 69, 73 of the internal cutting member 21 at the first and second distances D1 and D2 from the central axis 43 as shown in FIG. 4. Said increased average thickness of the radial end portions of the hair-guiding element 51 also increases the stiffness of the hair-guiding element 51. In particular, the average thickness of the hair-guiding element 51 may be further reduced in the central portion of the hair-guiding element 51 between the two radial end portions. As is further readily visible in FIG. 4, the total cross-sectional area A_{T} of the hair-guiding element 51 gradually varies from its maximum value at the first distance D1 from the central axis 43 to its minimum value in the central region of the hair-guiding element 51 around the third distance D3 from the central axis 43, and gradually varies from its minimum value in the central region of the hair-guiding element 51 around the third distance D3 from the central axis 43 to its maximum value at the second distance D2 from the central axis 43.

As further shown in FIG. 6A, the first hair-cutting element 67 and the second hair-cutting element 71 of the hair-cutting body 53 of the internal cutting member 21 are integrally formed on a carrying element 97 that is integrally formed with the base portion 55 of the internal cutting member 21. The carrying element 97 comprises an upper surface 99. In the cross-section of FIG. 6A the upper surface 99 extends in the imaginary plane 87 from the first cutting edge 69 to the second cutting edge 73. During rotation of the internal cutting member 21 about the axis of rotation 29 relative to the external cutting member 19, the upper surface 99 is in sliding contact with the annular inner surface 47 of the annular hair-cutting track 41 of the external cutting member 19, i.e. in sliding contact with the inner surface segments 57 of the hair-guiding elements 51. The carrying element 97 further comprises a first side surface 101 that connects to the upper surface 99 via the first cutting edge 69 of the first hair-cutting element 67. The carrying element 97 further comprises a second side surface 103 that connects to the upper surface 99 via the second cutting edge 73 of the second hair-cutting element 71.

Thus, in the embodiment of FIGS. 6A, 6B the first and second cutting edges 69, 73 of the internal cutting member 21 are integrally formed on opposite edges of the upper surfaces 99 of the carrying elements 97, and the first and second hair-cutting elements 67, 71 are formed by first and second upper portions of the carrying element 97. In alternative embodiments the first hair-cutting elements, carrying the first cutting edges of the internal cutting member 21 for co-operation with the first cutting edges 63 of the hair-guiding elements 51 of the external cutting member 21, and the second hair-cutting elements, carrying the second cutting edges of the internal cutting member 21 for co-operation with the first cutting edges 65 of the hair-guiding elements 51, may be formed by spatially separated carrying elements each carrying a respective one of the first and second cutting edges of the internal cutting member 21. Said spatially separated carrying elements may be mounted to or integrally formed on the base portion 55 of the internal cutting member 21.

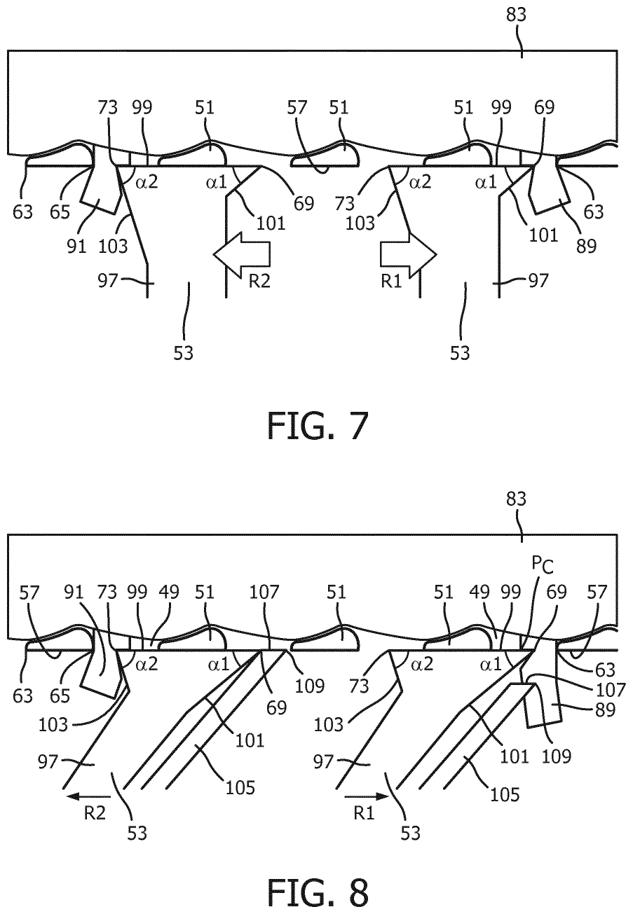

FIG. 7 schematically shows a cross-section similar to the cross-section of FIGS. 6A and 6B for a second embodiment of a hair-cutting unit according to the invention. In FIG. 7, features of the second embodiment that are similar to features of the embodiment shown in FIGS. 6A and 6B are indicated with similar reference numbers. In the following, only the differences between the second embodiment and the embodiment shown in FIGS. 6A and 6B will be described.

In the cross-section of the second embodiment of the hair-cutting unit according to the invention shown in FIG. 7, the first side surface 101 and the upper surface 99 of the carrying element 97 enclose a first cutting-edge angle α1 at the location of the first cutting edge 69 of the internal cutting member 21. In this cross-section the second side surface 103 and the upper surface 99 of the carrying element 97 enclose a second cutting-edge angle α2 at the location of the second cutting edge 73 of the internal cutting member 21. The first cutting-edge angle α1 is smaller than the second cutting-edge angle α2. The relatively small cutting-edge angle α1 at the first cutting edges 69 of the internal cutting member 21 improves the hair-cutting efficiency of the hair-cutting unit when the internal cutting member 21 is rotating in the first rotational direction R1 as illustrated in the right part of FIG. 7. The relatively small cutting-edge angle α1 may though also increase the level of skin irritation when the internal cutting member 21 is rotating in the first rotational direction R1. The relatively large cutting-edge angle α2 at the second cutting edges 73 of the internal cutting member 21 reduces the risk of skin irritation and thereby improves the skin comfort of the hair-cutting unit when the internal cutting member 21 is rotating in the second rotational direction R2 as illustrated in the left part of FIG. 7. The relatively large cutting-edge angle α2 may though also decrease the hair-cutting efficiency when the internal cutting member 21 is rotating in the second rotational direction R2. Thus, the different cutting-edge angles α1, α2 generally increase the difference between the hair-cutting efficiencies and the difference between the levels of skin comfort for the first and second rotational directions R1 and R2 of the internal cutting member 21.

FIG. 8 schematically shows a cross-section similar to the cross-section of FIGS. 6A, 6B and 7 for a third embodiment of a hair-cutting unit according to the invention. In FIG. 8, features of the third embodiment that are similar to features of the embodiments shown in FIGS. 6A, 6B and 7 are indicated with similar reference numbers. In the following, only the differences between the third embodiment and the embodiment shown in FIG. 7 will be described.

Similar to the second embodiment shown in FIG. 7, in the cross-section of the third embodiment of the hair-cutting unit according to the invention shown in FIG. 8 the first side surface 101 and the upper surface 99 of the carrying element 97 enclose a first cutting-edge angle α1 at the location of the first cutting edge 69 of the internal cutting member 21, and the second side surface 103 and the upper surface 99 of the carrying element 97 enclose a second cutting-edge angle α2 at the location of the second cutting edge 73 of the internal cutting member 21, wherein the first cutting-edge angle α1 is smaller than the second cutting-edge angle α2. In the third embodiment, the internal cutting member 21 further comprises a hair-retraction element 105 arranged in front of each carrying element 97, seen in the first rotational direction R1, for co-operation with the first cutting edge 69 of the hair-cutting body 53. The structure and function of such a hair-retraction element 105 and the way of incorporating such a hair-retraction element 105 into the internal cutting member 21 is known to the person skilled in the art and will not be described in detail. Reference is for example made to EP1212176B1 that describes in detail a hair-cutting unit comprising a similar hair-retraction or hair-pulling element. The hair-retraction element 105 comprises an end surface 107 having a cutting edge 109 at its side remote from the carrying element 97. The hair-retraction element 105 is moveably guided relative to the carrying element 97 along the first side surface 101 of the carrying element 97. Furthermore, the hair-retraction element 105 is urged by spring force towards the annular inner surface 47 of the annular hair-cutting track 41 of the external cutting member 19, i.e. towards the inner surface segments 57 of the hair-guiding elements 51. Constructional details to enable the guidance and urging of the hair-retraction element 105 as mentioned here before may be similar to those described in EP1212176B1.

During rotation of the internal cutting member 21 in the first rotational direction R1 as illustrated in the right part of FIG. 8, a hair 89 penetrating into a hair-entry opening 49 will first be caught by the cutting edge 109 of the hair-retraction element 105. The cutting edge 109 will only partially penetrate the hair 89 and, as a result, will extract the hair 89 over a certain distance out of the skin 83 during further rotation of the carrying element 97. It is noted that, in the right part of FIG. 8, the hair-retraction element 105 is shown in a retracted position after extracting the hair 89 out of skin 83, while the left part of FIG. 8 shows the hair-retraction element 105 in its rest position before catching a hair. Subsequently the hair 89 will be cut through by the co-operation between the first cutting edge 69 of the carrying element 97 and the first cutting edge 63 of the co-operating hair-guiding element 51. Because the hair 89 was initially extracted out of the skin by the hair-retraction element 105, the hair 89 will retract again into the skin after being cut through. As a result, a cutting position Pc where the hair 89 is cut will also retract into a position close to or even below the surface of the skin, so that the closeness of the hair-cutting process at the first cutting edges 69 of the internal cutting member 21 is further improved. Because, during rotation of the internal cutting member 21 in the second rotational direction R2 as illustrated in the left part of FIG. 8, the hair-retraction elements 105 do not influence the hair-cutting process at the second cutting edges 73 of the internal cutting member 21, the hair-retraction elements 105 further increase the difference between the hair-cutting efficiencies for the first and second rotational directions R1 and R2 of the internal cutting member 21.

1. An external cutting member for use in a hair-cutting unit of a shaving device, said external cutting member comprising an annular hair-cutting track having:
an outer surface for contacting a skin of a user during use;
an inner surface for contacting an internal cutting member of the hair-cutting unit during use;
a central axis;
a plurality of hair-entry openings each extending from the outer surface to the inner surface; and
a hair-guiding element arranged between a first hair-entry opening and an adjacent second hair-entry opening of the plurality of hair-entry openings;
wherein said hair-guiding element comprises:
an outer surface segment comprised by said outer surface;
an inner surface segment comprised by said inner surface;
a first side surface bounding the first hair-entry opening;
a second side surface bounding the second hair-entry opening;
a first cutting edge at a location where the first side surface connects to the inner surface segment; and
a second cutting edge at a location where the second side surface connects to the inner surface segment;
wherein, in a cross-section of the hair-guiding element extending perpendicularly to a radial direction with respect to the central axis:
the inner surface segment extends between the first and second cutting edges in an imaginary plane perpendicular to the central axis;
the hair-guiding element has an imaginary middle axis extending perpendicularly to the inner surface segment, intersecting the inner surface segment in a point of intersection half-way between the first and second cutting edges, and dividing a total cross-sectional area of the hair-guiding element into a first cross-sectional area portion including the first cutting edge and a second cross-sectional area portion including the second cutting edge, the total cross-sectional area being the sum of the first and second cross-sectional area portions;
characterized in that the first cross-sectional area portion of the hair-guiding element is equal to or smaller than 48% of the total cross-sectional area of the hair-guiding element.

2. The external cutting member as claimed in claim 1, wherein the first cross-sectional area portion is between 30% and 45% of the total cross-sectional area.

3. The external cutting member as claimed in claim 1, wherein a hair-guiding element is arranged between each pair of adjacent hair-entry openings of the plurality of hair-entry openings.

4. The external cutting member as claimed in claim 1, wherein, in said cross-section of the hair-guiding element, a thickness of the hair-guiding element measured in a direction perpendicular to the inner surface segment has a maximum value at a maximum-thickness position between the imaginary middle axis and the second cutting edge, wherein said thickness increases from the first cutting edge to the maximum-thickness position and decreases from the maximum-thickness position to the second cutting edge.

5. The external cutting member as claimed in claim 1, wherein the hair-guiding element has the first cross-sectional area portion and the second cross-sectional area portion in a cross-section perpendicular to the radial direction in any position from a first distance from the central axis to a second distance from the central axis different from the first distance.

6. The external cutting member as claimed in claim 5, wherein, in positions at said first and second distances from the central axis, the total cross-sectional area of the hair-guiding element is larger than the total cross-sectional area of the hair-guiding element in a position at a third distance from the central axis between said first and second distances.

7. The external cutting member as claimed in claim 6, wherein the total cross-sectional area of the hair-guiding element gradually varies between said first and second distances from the central axis.

8. A hair-cutting unit for use in a shaving device, said hair-cutting unit comprising:
an external cutting member as claimed in claim 1; and
an internal cutting member which is rotatable relative to the external cutting member about an axis of rotation in a first rotational direction and in a second rotational direction opposite to the first rotational direction;
wherein:
the internal cutting member comprises at least a first hair-cutting element comprising a first cutting edge and a second hair-cutting element comprising a second cutting edge;
in a common cross-section of the first and second hair-cutting elements extending perpendicularly to a radial direction with respect to the axis of rotation, the first and second cutting edges of the first and second hair-cutting elements are situated in an imaginary plane perpendicular to the axis of rotation;
the first cutting edge of the first hair-cutting element is arranged to co-operate with the first cutting edge of the hair-guiding element of the external cutting member during rotation of the internal cutting member in the first rotational direction; and
the second cutting edge of the second hair-cutting element is arranged to co-operate with the second cutting edge of the hair-guiding element of the external cutting member during rotation of the internal cutting member in the second rotational direction.

9. A hair-cutting unit as claimed in claim 8, wherein the first and second hair-cutting elements are integrally formed on a carrying element which comprises:
an upper surface for contacting the inner surface of the external cutting member during use;
a first side surface connected to the upper surface via the first cutting edge of the first hair-cutting element; and
a second side surface connected to the upper surface via the second cutting edge of the second hair-cutting element;
wherein, in said common cross-section of the first and second hair-cutting elements, the upper surface extends in said imaginary plane perpendicular to the axis of rotation.

10. The hair-cutting unit as claimed in claim 9, wherein, in said common cross-section of the first and second hair-cutting elements, the first side surface and the upper surface of the carrying element enclose a first cutting-edge angle at the location of the first cutting edge of the first hair-cutting element, and the second side surface and the upper surface of the carrying element enclose a second cutting-edge angle at the location of the second cutting edge of the second hair-cutting element, wherein the first cutting-edge angle is smaller than the second cutting-edge angle.

11. The hair-cutting unit as claimed in claim 9, wherein the internal cutting member further comprises a hair-retraction element arranged in front of the carrying element seen in the first rotational direction for co-operation with the first cutting edge of the first hair-cutting element said hair-retraction element:
comprising an end surface having a cutting edge at a side of the end surface remote from the carrying element;
being moveably guided relative to the carrying element along the first side surface of the carrying element; and
being urged by spring force towards the inner surface of the external cutting member.

12. A shaving head comprising:
a support structure including a coupling member configured to releasably couple the shaving head to a main body of a shaving device; and
at least one hair-cutting unit as claimed in claim 8 supported by the support structure.

13. A shaving device comprising:
at least one hair-cutting unit as claimed in claim 8; and
an actuator for driving the hair-cutting unit;
wherein the actuator is configured and arranged to:
operate in a first operational condition wherein the actuator drives the hair-cutting unit such that the internal cutting member rotates relative to the external cutting member in the first rotational direction; and
operate in a second operational condition wherein the actuator drives the hair-cutting unit such that the internal cutting member rotates relative to the external cutting member in the second rotational direction.

14. A shaving device comprising:
a main body accommodating an actuator; and
a shaving head as claimed in claim 12 which is releasably couplable to the main body for being driven by the actuator;
wherein the actuator is configured and arranged to:
operate in a first operational condition wherein the actuator drives the shaving head such that the internal cutting member of the hair-cutting unit rotates relative to the external cutting member in the first rotational direction; and
operate in a second operational condition wherein the actuator drives the shaving head such that the internal cutting member of the hair-cutting unit rotates relative to the external cutting member in the second rotational direction.

15. The shaving device as claimed in claim 13, further comprising a control unit configured and arranged to selectively control the actuator to operate in the first or the second operational condition.

16. The shaving device as claimed in claim 13, further comprising a user input member enabling the user to select the first and second operational conditions.
